(19) United States
(12) Patent Application Publication
(10) Pub. No.: US 2008/0001706 A1
(43) Pub. Date: Jan. 3, 2008

(54) Low power detection method for proximity lock

(75) Inventors: Mohamad KhaIil, Sterling Heights, MI (US); Bryan Urben, Troy, MI (US); Mike Scott, Lapeer, MI (US); Jeffrey W. Campbell, Troy, MI (US)

Correspondence Address: CARLSON, GASKEY & OLDS, P.C., 400 WEST MAPLE ROAD, SUITE 350, BIRMINGHAM, MI, 48009, US

(73) Assignee: Kaba IIco Inc.

(21) Appl. No.: 11/595,041

(22) Filed: Nov. 10, 2006

Related U.S. Application Data
(60) Provisional application No. 60/814,778, filed on Jun. 19, 2006.

(51) Int. Cl. G06F 7/00

(52) U.S. Cl. 340/5.61; 340/10.1

(57) ABSTRACT

A proximity lock is battery powered and includes an infrared (IR) circuit for detecting the presence of an authentication device and a radio frequency (RF) circuit for communicating with the authentication device. RF signals emitted from an RF circuit are received by an antenna within the authentication device. An IR signal recognizes the presence of the authentication device and prompts the RF circuit to communicate with the authentication device.

### CROSS REFERENCE TO RELATED APPLICATION

The application claims priority to U.S. Provisional Application No. 60/814,778 which was filed on Jun. 19, 2006.

### BACKGROUND OF THE INVENTION

This invention generally relates to a system and method for operating a proximity lock. More particularly, this invention relates to a device for detecting the presence of a proximity identification device utilizing a reduced amount of power.

A radio frequency identification (RFID) tag is an electronic device that transmits an identification signal in response to a transmission received from another source. One use of an RFID tag is within a proximity card. The card is placed in close proximity to a card reader. The card reader transmits a radio frequency signal that excites the RFID tag within the card. The RFID tag within the card in turn transmits a signal that is received by the card reader. The signal provides identification and access information that is confirmed by the card reader to allow operation of a lock or other access control device.

Disadvantageously, the RF signal transmitted by the card reader requires a good deal of power and a relatively expensive RF switch. The RF prompt signal is sent out at intervals to scan for and locate a proximity card. In many applications the large amount of power required to transmit periodic RF signals is of no concern, as the card reader or transmission device is hardwired into existing building power. However, in some applications, the card reader is powered by batteries that have a limited life span.

Accordingly, it is desirable to develop and design a device that detects the presence of a proximity card with a reduced amount of electric power, and at a lower cost.

### SUMMARY OF THE INVENTION

An example proximity lock is battery powered and includes an infrared circuit for detecting the presence of an authentication device and a radio frequency circuit for communicating with the authentication device.

An example proximity lock communicates with an authentication device through a radio frequency (RF) connection. RF signals emitted from an RF circuit are received by a transceiver within the authentication device. The received signal provides the required energy to excite a transponder within the authentication device. The transponder emits a signal including identification and access information back to the RF circuit. This identification and access information is verified and the proximity lock appropriately operated as a result of the verified information.

The example proximity lock is powered by several batteries, and therefore there is a need to conserve power to extend the operational life of the batteries. Conventional, hard wired proximity locks simply emit an RF signal at desired intervals until a return RF signal is received. This method and process is energy intensive and not desirable for the example proximity lock.

The example proximity lock increases the duration between required battery changes by using a pulsing IR signal driven by a relatively low cost IR microprocessor. The pulsing IR signal recognizes the presence of the authentication device instead of using a pulsing RF signal that requires a relatively a large amount of energy as compared to the IR microprocessor. Once the presence of the authentication device is recognized, the RF circuit is engaged to communicate with the authentication device.

Accordingly, prompting operation of the RF circuit by low power consumption IR circuit extends the operational life of batteries powering the example proximity lock assembly.

### BRIEF DESCRIPTION OF THE DRAWINGS

The features of the present invention can be best understood from the following specification and drawings, the following of which is a brief description.

FIG. 1, is a schematic view of an example proximity lock and card according to this invention.

### DETAILED DESCRIPTION OF THE PREFERRED EMBODIMENT

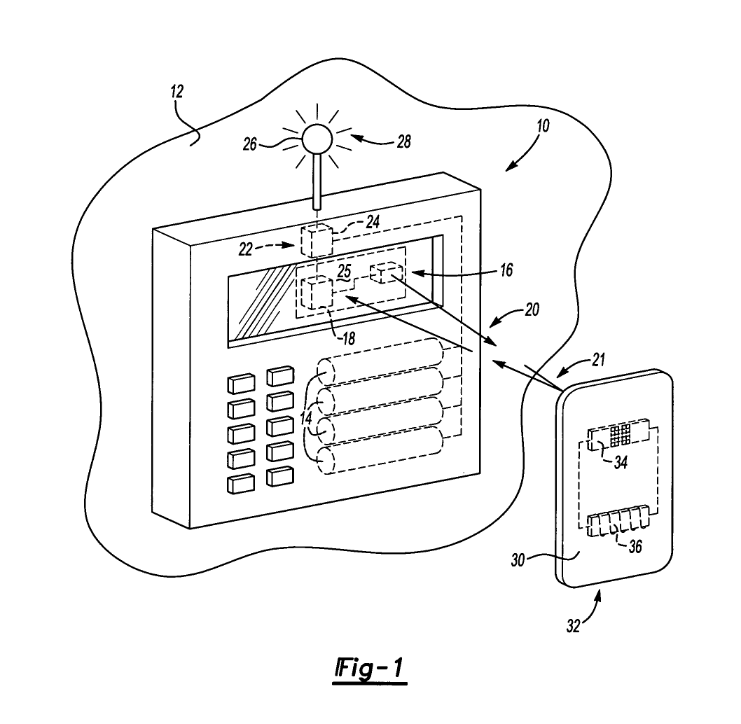

Referring to FIG. 1, a proximity lock 10 communicates with an identification card 30 through a radio frequency (RF) connection facilitated by an RF circuit 22 including an RF antenna 26 controlled by an RF transponder 24. RF signals 28 emitted by the RF antenna 26 are received by an RF antenna 36 within the card 30. The received signal provides the required energy to excite a transponder 34 within the card 30. Although a card 30 is disclosed by way of example other authentication devices are also within the contemplation of this invention. The term transponder is utilized in this disclosure to refer to the device, or circuit that receives RF signals and emits an RF signal in reply. Further, the transponder may be powered by the RF signal or may include a dedicated power supply. The transponder 34 emits a signal including identification and access information back to the lock 10 responsive to the signal from the RF circuit 22 within the lock 10. This identification and access information is verified and the proximity lock 10 appropriately operated as a result of the verified information.

The example proximity lock 10 is powered by several batteries 14, and therefore there is a need to conserve power to extend the operational life of the batteries 14. Conventional, hard wired proximity locks simply emit an RF signal at desired intervals until a return RF signal is received. This method and process is energy intensive and not desirable for the example proximity lock 10.

The example proximity lock 10 includes an infrared (IR) circuit 25. The IR circuit 25 consumes less power than the RF circuit 22. The IR circuit 25 includes an IR transceiver 16 controlled by an IR microprocessor 18 to emit IR energy 20. The IR energy 20 is emitted at desired intervals to detect the presence of the card 30. IR energy 20 is emitted and reflects off the card 30, as indicated at 21, and detected by the IR transceiver 16. The receipt of IR energy 20 by the IR transceiver 16 is indicative of the presence of the card 30.

The IR microprocessor 18 then signals the RF circuit 22 to “wake-up” and begin sending RF signals 28. In this way, the RF circuit 22 remains dormant at a setting that utilizes little if any power until the IR circuit 25 detects the presence of the card 30. Once the card 30 is detected, RF communication is initiated and proceeds.

The example proximity lock 10 increases the duration between required battery changes by using the pulsing IR energy 20 driven by a relatively low cost IR microcontroller 18. The pulsing IR energy 20 recognizes the presence of the card 30 instead of using a pulsing RF signal that requires a relatively expensive RF switch to search for an RF response from the card 30.

The example IR circuit 25 provides an analog output that is utilized to provide the desired wake-up signal to the RF circuit 22. The IR circuit 25 is variable in that there are provisions provided for adjusting a distance at which the card 30 is detected. In the disclosed example, the card 30 is detected at a relatively close proximity to the lock 10. The close proximity to the lock 10 is such that a random swipe or movement close to the lock is not likely to be detected by the IR circuit 25.

Operation of the lock device 10 begins with the proximity lock 10 in a dormant condition. Dormant meaning that the RF circuit 22 is in an “off” or sleep mode where little if any power is consumed. The IR circuit 25 drives the IR transceiver 16 to emit pulses of IR energy 20 at desired intervals. Placement of the card 30 proximate to the lock 10 causes some of the pulses of IR energy 20 to reflect back to the IR transceiver 16, as indicated at 21. The reflected IR energy 21 received by the IR circuit 25 prompts a “wake-up” signal to the RF circuit 22. The RF circuit 22 then powers up and begins emitting the desired RF signals 28 to communicate with the RF circuit 32 within the card 30. The RF circuit 22 then receives information from the card 30 through the RF communication link that provides for operation as the lock 10 as is desired according to the information provided by the card 30.

Once the card 30 is removed from proximity to the proximity lock 10, the RF circuit 22, will return to an off or sleep condition after a desired time, and the IR circuit 25 will return to sending out IR energy pulses 20 at desired intervals until another card 30 is detected.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A proximity lock comprising:
a radio frequency (RF) circuit for communicating with an authorization device; and
an infrared (IR) circuit for emitting and detecting IR energy, wherein the IR circuit detects a presence of an authorization device and initiates operation of the RF circuit responsive to detection of the authorization device.

2. The proximity lock as recited in claim 1, wherein the RF circuit includes a dormant state and an operative state and the RF circuit operates in the dormant state when the IR circuit does not detect the presence of an authorization device and in the operative state responsive to the IR circuit indicating the presence of the authorization device.

3. The proximity lock as recited in claim 2, wherein the RF circuit comprises an RF antenna for emitting and receiving signals from an authentication device.

4. The proximity lock as recited in claim 1, wherein the authorization device includes a transponder for sending an authentication signal responsive to a signal emitted by the RF circuit.

5. The proximity lock as recited in claim 4, wherein the transponder is powered by the signal emitted by the RF circuit.

6. The proximity lock as recited in claim 1, wherein the IR circuit consumes less electrical energy than the RF circuit.

7. The proximity lock as recited in claim 1, wherein the proximity lock includes at least one battery for powering the RF circuit and the IR circuit.

8. The proximity lock as recited in claim 1, wherein the IR circuit includes an IR transceiver for emitting and receiving infrared energy.

9. The proximity lock as recited in claim 1, wherein the authorization device comprises a card including a transponder that emits a verification signal responsive to receipt of a signal from the RF circuit.

10. A method of operating a proximity lock assembly comprising the steps of:
a) emitting infrared energy from the proximity lock assembly;
b) searching for infrared energy reflected back to the proximity lock assembly by an authentication device; and
c) emitting a radio frequency signal for communicating with the authentication device responsive to detecting infrared energy reflected back to the proximity lock assembly.

11. The method as recited in claim 10, wherein the step of emitting a radio frequency signal for communicating with the authentication device comprises sending a first radio frequency signal from the proximity lock to the authentication device and sending a second radio frequency signal from the authentication device to the proximity lock responsive to receipt of the first radio frequency signal.

12. The method as recited in claim 11, wherein the authentication device includes a transponder operable to sent the second signal responsive to receipt of the first signal.

13. The method as recited in claim 11, including the step of providing access to the proximity lock responsive to the second signal from the authentication device meeting a desired criteria specific to the proximity lock assembly.

14. The method as recited in claim 10, including the step of switching a radio frequency circuit of the proximity lock from a low power mode where no radio frequency signals are emitted to an operation mode where radio frequency signals are emitted responsive to detecting the presence of the authentication device.

15. The method as recited in claim 10, including the step of adjusting a quantity and frequency of infrared energy emitted from the proximity lock.
